(19) United States
(12) Patent Application Publication
(10) Pub. No.: US 2017/0357987 A1
(43) Pub. Date: Dec. 14, 2017

(54) ONLINE PLATFORM FOR PREDICTING CONSUMER INTEREST LEVEL

(71) Applicant: Clickagy, LLC, Alpharetta, GA (US)

(72) Inventors: Harry Russell Maugans, III, Alpharetta, GA (US); Cody Alan Carrell, Alpharetta, GA (US); Kenneth Jørgensen, Alpharetta, GA (US); Deepak Gopalakrishnan, Alpharetta, GA (US)

(21) Appl. No.: 15/689,845

(22) Filed: Aug. 29, 2017

Related U.S. Application Data
(63) Continuation-in-part of application No. 15/177,168, filed on Jun. 8, 2016.
Application No. 15/177,168 is a continuation-in-part of application No. 15/177,178, filed on Jun. 8, 2016.
Application No. 15/177,178 is a continuation-in-part of application No. 15/177,193, filed on Jun. 8, 2016.
(60) Provisional application No. 62/173,071, filed on Jun. 9, 2015.
(60) Provisional application No. 62/173,071, filed on Jun. 9, 2015.
(60) Provisional application No. 62/173,071, filed on Jun. 9, 2015.

(51) Int. Cl. G06Q 30/02; G06N 99/00; G06Q 20/10; G06Q 20/20; G06F 17/30

(52) U.S. Cl. CPC G06Q 30/0201; G06Q 20/20; G06F 17/30377; G06Q 20/102; G06N 99/005

(57) ABSTRACT

Disclosed is an online platform for predicting consumer interest level based on online behavior of consumers. The platform may be configured to monitor online activity of consumers across a plurality of webpages. As a result, the plurality of webpages visited by the consumer may be determined by the online platform. Further, the online platform may be configured to access and parse each webpage in the plurality of webpages in order to extract key elements. Furthermore, the platform may be configured to aggregate key elements extracted from each of the plurality of webpages and perform an analysis. Based on the analysis, the consumer may be determined to be in-market with regard to a product and/or a service. Further, based on the analysis, a confidence value representing a degree to which the consumer is in-market with respect to the product and/or the service may also be determined.

### RELATED APPLICATIONS

The present application is a continuation-in-part filing of the following U.S. utility patent applications:

U.S. patent application Ser.No. 15/177,168, entitled “METHOD, SYSTEM AND COMPUTER READABLE MEDIUM FOR CREATING A PROFILE OF A USER BASED ON USER BEHAVIOR,” having Attorney Docket No. 279E.P001US01, and claiming priority to U.S. Provisional Patent Application No. 62/173,071 filed on Jun. 9, 2015. The disclosure of the aforementioned application is incorporated by reference herein as “the '168 disclosure.”

U.S. patent application Ser. No. 15/177,178, entitled “METHOD AND SYSTEM FOR PROVIDING BUSINESS INTELLIGENCE BASED ON USER BEHAVIOR,” having Attorney Docket No. 279E.P001US02, and claiming priority to U.S. Provisional Patent Application No. 62/173,071 filed on Jun. 9, 2015. The disclosure of the aforementioned application is incorporated by reference herein as “the '178 disclosure.”

U.S. patent application Ser. No. 15/177,193, entitled “METHOD AND SYSTEM FOR CREATING AN AUDIENCE LIST BASED ON USER BEHAVIOR DATA,” having Attorney Docket No. 279E.P001US03, and claiming priority to U.S. Provisional Patent Application No. 62/173,071 filed on Jun. 9, 2015. The disclosure of the aforementioned application is incorporated by reference herein as “the '193 disclosure.”

The disclosures above-referenced applications are hereby incorporated into the present application by reference, in their entirety. It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to online behavioral analysis. More specifically, the present disclosure relates to monitoring and analyzing online behavior of consumers in order to determine if consumers are in-market for one or more products and/or services. The present disclosure further relates to determining whether are interested in one or more products and/or services.

### BACKGROUND

With advancements in technologies, consumers are exposed to an increasing amount of information on a daily basis. In particular, the advent of mobile technologies has enabled unprecedented accessibility to information irrespective of time or place. As a result, consumers increasingly face difficulty in receiving information relevant to them. In other words, information currently presented to consumers is largely irrelevant to the user's interests and/or intentions. Further, although existing systems perform targeted information dissemination to some extent by identifying consumers' interests, such techniques are limited. For instance, existing systems target content, such as infomercials to consumers based on key elements present on a webpage being viewed by the user. As a result, consumers may not be able to view information, such as advertisements regarding products and/or services that is relevant to their immediate needs or intentions.

On the other hand, content providers, such as webpage publishers also face challenges in accurately identifying interests and/or intentions of consumers. Existing techniques largely rely on information regarding interests explicitly provided by consumers. However, such interests may be large in number, while a user at any given time may be interested in a smaller subset of such interests. Further, user interests vary in time and accordingly to contexts. As a result, information regarding interests may not be dynamic in nature to follow such variations.

Accordingly, there is a need for methods and systems for identifying user interests and/or intentions based on user behavior, such as online behavior.

### Brief Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed is an online platform for predicting consumer interest level based on online behavior of consumers. The platform may be configured to monitor online activity of consumers across a plurality of webpages. Accordingly, each webpage of the plurality of webpages may include a tracking cookie configured to identify a user accessing a respective webpage based on a unique ID of the user. Alternatively, each webpage of the plurality of webpages may include code configured to retrieve a tracking cookie from a user device of the user. The ID is associated with the plurality of visited webpages. As a result, the plurality of webpages visited by the user may be determined and aggregated by the online platform for each visitor.

Further, the online platform may be configured to access each webpage in the plurality of webpages and retrieve content, such as, but not limited to, textual content, from each webpage. The content retrieved from each web page may be parsed in order to extract key elements. The platform may be configured to aggregate key elements extracted from each of the plurality of webpages and perform an analysis, such as, but not limited to, a machine learning or Artificial Intelligence (AI) based analysis on the aggregate key elements. Based on the analysis, the user may be determined to be in-market with regard to a product and/or a service. Further, based on the analysis, a confidence value representing a degree to which the user is in-market with respect to the product and/or the service may also be determined. Accordingly, based on determining the user as in-market, content, such as advertisements, associated with the product and/or the service may be presented to the user.

In some embodiments, the presentation of the confidence value may be integrated with an existing CRM platform associated with a platform user. In this way, the CRM platform may be used to trigger marketing campaigns to consumers with certain in-market scores/confidence levels.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a block diagram of an operating environment consistent with the present disclosure.

FIG. 2 illustrates a flowchart of a method 200 of tracking a user across multiple webpages in order to determine in-market status of the user, in accordance with some embodiments.

FIG. 3 illustrates a flowchart of a method 300 of determining in-market status of consumers, in accordance with some embodiments.

FIG. 4 illustrates a block diagram of a system 400 for implementing the online platform for predicting consumer interest level, in accordance with some embodiment.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of stages of various processes or methods that are described herein are illustrative and not restrictive. Accordingly, it should be understood that, although stages of various processes or methods may be shown and described as being in a sequence or temporal order, the stages of any such processes or methods are not limited to being carried out in any particular sequence or order, absent an indication otherwise. Indeed, the stages in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “stage for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of in-market status with respect to products and/or services, embodiments of the present disclosure are not limited to use only in this context. For example, the platform may also be used to identify fine-grained interests and/or intentions of performing actions (e.g. attending an event, performing a physical activity, meeting a person, etc.).

I. Platform Overview

Consistent with embodiments of the present disclosure, an online platform for predicting consumer interest level (also referred to herein as “platform”) may be provided. This overview is provided to introduce a selection of concepts in a simplified form that are further described below. This overview is not intended to identify key features or essential features of the claimed subject matter. Nor is this overview intended to be used to limit the claimed subject matter's scope.

The online platform may be used by individuals or companies to identify consumers who may be in-market for a product and/or a service with a calculated degree of confidence. Accordingly, targeted information, such as for example, advertisements may be presented to such consumers in order to aid the consumers to make informed buying decisions while also enhancing the likelihood of a user making a purchase of the product and/or service. Although embodiments of the present disclosure may be disclosed with reference to a “webpage publisher” or a “content provider” as a platform user, any individual or entity may be a platform user.

The present disclosure provides methods of and systems for predicting a consumer as being in-market, based on collection and scoring (either statistically or using machine learning) of pieces of data extracted from webpages visited by the consumer.

One possible user of the platform may be, for example, a webpage publisher. A webpage publisher may join a network of publishers (e.g. an ad-network) in order to collectively determine in-market status of consumers. The network may be associated with a plurality of webpages, each tracking-enabled. Tracking the consumers' online behavior may include identifying webpages visited by the consumers when those webpages are, for example, part of the network. In an instance, this may be accomplished by aggregating a large network of webpage publishers who have a common element on their webpage. The common element may be the use of a network recognized cookie, or identifier, for each visitor who accesses any one webpage of the network of webpages. In some instances, multiple such networks of webpages may associate, share or sell information amongst each other to build larger networks, thereby expanding the webpage base for online behavioral tracking.

Further, in some instances, each webpage of the network of webpages may include a component configured to execute on a respective webpage and affect an action on a user device of the user visiting the respective webpage. The component may include, for example, but not limited to, Javascript code. Additionally, in some instances, the Javascript code may be configured for provisioning advertisements on the respective webpage.

Accordingly, the present disclosure enables a webpage publisher to determine if a user visiting the webpage is ‘in-market’ for products and/or services that the webpage publisher provides. This is advantageous because if the user is ‘in-market’, the webpage publisher may execute an appropriate marketing or sales campaign to increase the likelihood that the user converts to a customer. (See the '193 disclosure.)

Still consistent with embodiments of the present disclosure, a platform user may not be a webpage publisher. Moreover, a platform user may specify certain criteria for determining an in-market user without being required to add any code to a webpage or join a network.

As an example, regardless of whether the platform use is a content provider, the platform user may specify that it seeks to locate consumers in the market for purchasing a computing device. The platform may then, in turn, commence an analysis of online behavioral data aggregated from multiple sources. One source may be, for example, but not limited to an ad network. Upon analysis, the platform may determine that a potential in-market consumer has visited three computing device review webpages. Accordingly, by tracking the consumer's online activity, the methods and systems disclosed herein may determine that the person looked at ‘tablet computing devices’ twice and focused on reviews considering “battery life”. Such information may be extracted from the multiple data sources by the platform using a plurality of techniques. Such as, for example, but not limited to, using a web crawler or from Javascript code running on the webpages at the time the person visited them. Further, and as will be detailed below, the key elements extracted from the visited web pages may be analyzed in order to determine whether the consumer is in-market for or interested-in a product and/or a service. (See the '168 disclosure.)

In some embodiments, the methods and systems disclosed herein may also calculate a confidence score associated with the in-market status of the person with respect to the product and/or the service. For instance, the methods and systems disclosed herein may be able to determine that the person is 73% in-market for an Apple iPad, 59% in market for a Microsoft Surface, and 32% in market for some other tablet computing device. (See the '178 disclosure.)

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

II. Platform Configuration

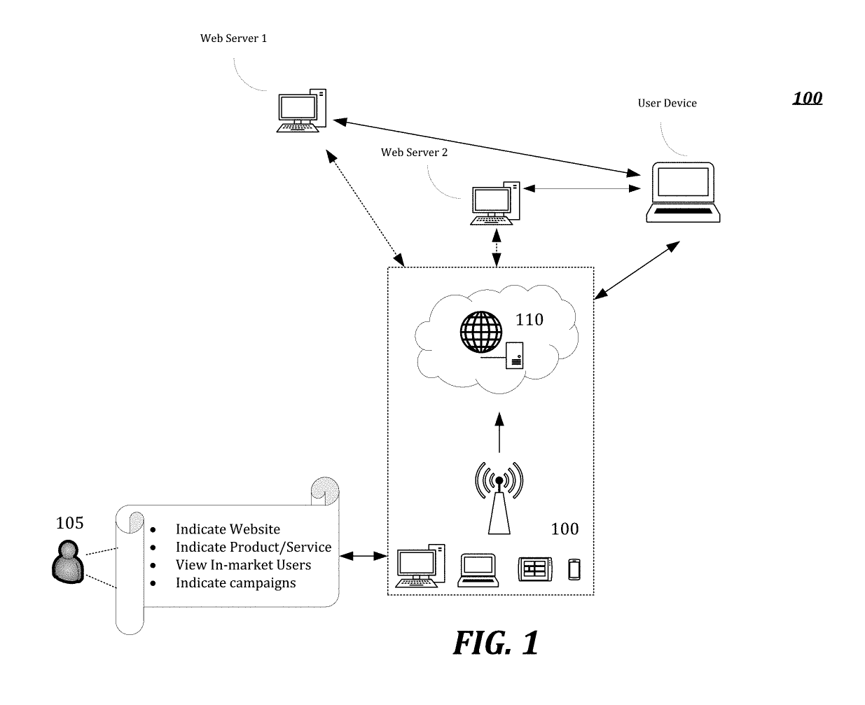

FIG. 1 is an illustration of a platform consistent with various embodiments of the present disclosure. By way of non-limiting example, the online platform 100 for predicting consumer interest level may be hosted on a centralized server 110, such as, for example, a cloud computing service. The centralized server may communicate with other network entities, such as, for example, a plurality of webpage servers (e.g. web server 1 and 2) hosting a plurality of webpages and a user device (e.g. laptop computer, smartphone, tablet computer, desktop computer etc.). Additionally, in some embodiments, the centralized server may also communicate with other entities such as databases, wearable devices, Point Of Sales (POS) terminals etc. In general, the centralized server may be configured to communicate with any entity capable of providing user behavior data that is representative of a buying intention of a consumer. A user 105, such as a manager of the online platform 100 and/or an administrator of a webpage may access platform 100 through a software application. The software application may be embodied as, for example, but not be limited to, a webpage, a web application, a desktop application, and a mobile application compatible with a computing device 400. One possible embodiment of the software application may be provided by “In-Market Audiences”TM suite of products and services. Accordingly, the user 105 may provide, for example, indication of a list of webpages, indication of one or more products and/or services offered by a webpage of the list of webpages and indication of one or more campaigns to be targeted to the consumer's with a detected interest level (hereinafter referred to “in-market consumers”). In response, the platform may identify in-market consumers based on online behavior and enable the user 105 to view the in-market consumers along with confidence values associated with products and/or services corresponding to which the in-market consumers are identified.

In order to determine the in-market consumers, the platform may be configured to track online activity of consumers. For instance, in some embodiments, the platform may be configured to use client-side or server side cookies in order to track a user across a plurality of webpages. Accordingly, a cookie stored in the consumer device may be used to log each webpage of the plurality of webpages visited by the consumer device. Alternatively, the plurality of webpages may cooperate with each other to track the consumer device accessing each of the plurality of webpages. In other words, cookies stored at web servers corresponding to the plurality of webpages may log each access by the consumer device and may communicate such accesses amongst the plurality of web servers.

As an example, the consumer device may visit a webpage hosted on web sever 1 and 2 within a short period of time, such as a day. Accordingly, each of web server 1 and 2 may create a log of the consumer device, represented by a unique ID, such as for example, a network address, an IMEI number, a combination of software, hardware and demographic information associated with a person operating the consumer device and so on. Such logs may be shared amongst the web servers by aggregating the logs at a single location, such as at the platform.

As a result of the tracking, for each unique ID representing a consumer, a list of webpages may be identified. The platform may then access each webpage in the list of webpage in order to retrieve key elements present in the content of each webpage. For example, the platform may perform scraping, OCR etc. in order to parse the content of each webpage. Further, the key elements may be aggregated and an analysis may be performed on the aggregated key elements in order to identify in-market status of the consumer towards one or more products and/or services. Key elements may be analyzed based on a set of criteria in order to determine the corresponding consumer's in-market status. For example, the platform may be configured to assess various factors associated with the key elements, including, but not limited to, keywords, keyword density (e.g., frequency of occurrence on a webpage), themes associated with the webpage, time spent on a webpage, quantity of pages visited with related key elements, relevant pages, and parameters associated therewith. The analysis may be embodied using, at least in part, various machine learning methods and techniques. In turn, the analysis may also identify a confidence value associated with each product and/or service to which the in-market consumer status corresponds.

In one example, online behavioral data may be combined with purchasing data, retrieved from sales database, POS terminals etc. The combination may then be used to identify patterns of online browsing activity representing buying intentions. Such patterns may be identified by performing machine learning over the historical online browsing data (including purchasing data in some embodiments). Subsequently, the machine learning may be used to identify in-market status of the consumer based on currently received online behavior data.

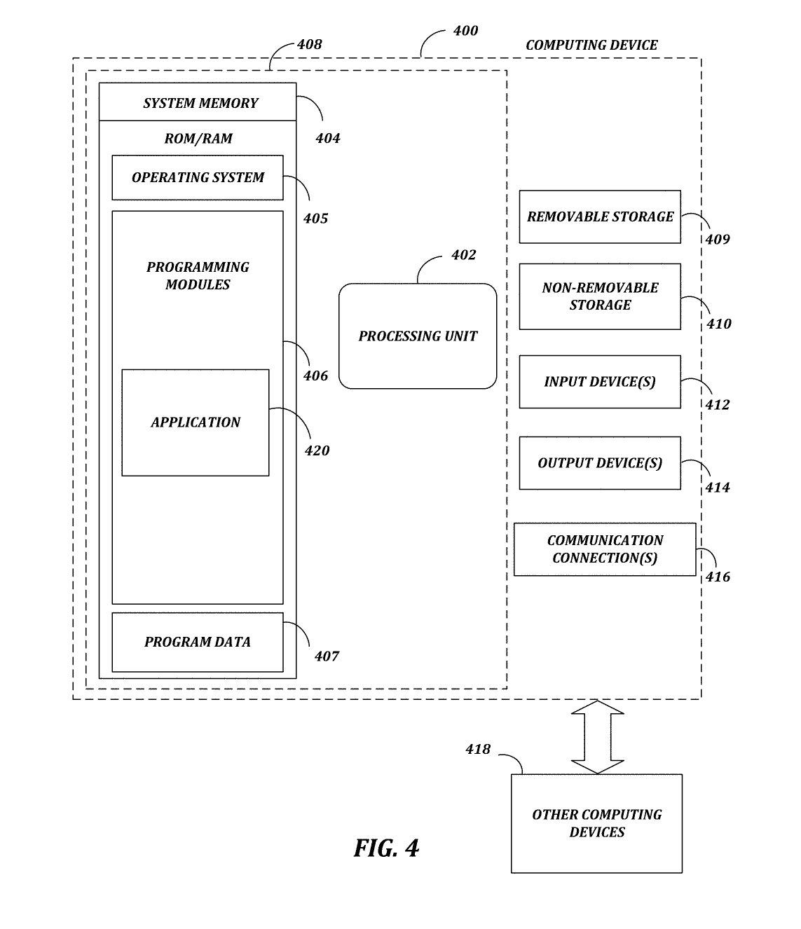

As will be detailed with reference to FIG. 4 below, the computing device through which the platform may be accessed may comprise, but not be limited to, for example, a desktop computer, laptop, a tablet, or mobile telecommunications device. As will be detailed with reference to FIG. 4 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

III. Platform Operation

Although methods 200 and 300 have been described to be performed by platform 100, it should be understood that computing device 400 may be used to perform the various stages of methods 200 and 300. Furthermore, in some embodiments, different operations may be performed by different networked elements in operative communication with computing device 400. For example, server 110 may be employed in the performance of some or all of the stages in methods 200 and 300. Moreover, server 110 may be configured much like computing device 400.

According to some embodiments, the method may include a setup or ‘on-boarding’ phase, in which the targeted products and/or services for a platform user may be determined. In some embodiments, determining the products and/or services may be performed automatically by scraping/parsing a platform user's webpage for key elements. Alternatively, the platform user may provide inputs indicating the target products and/or services. Accordingly, in some instances, key elements associated with the webpage offering the products and/or services may be determined. These key elements may then serve as a base reference point when analyzing other webpages to determine in-market or interest status for a consumer. Having the base reference point set, the platform may be enabled to perform at least one of the following stages, in any order, at any time.

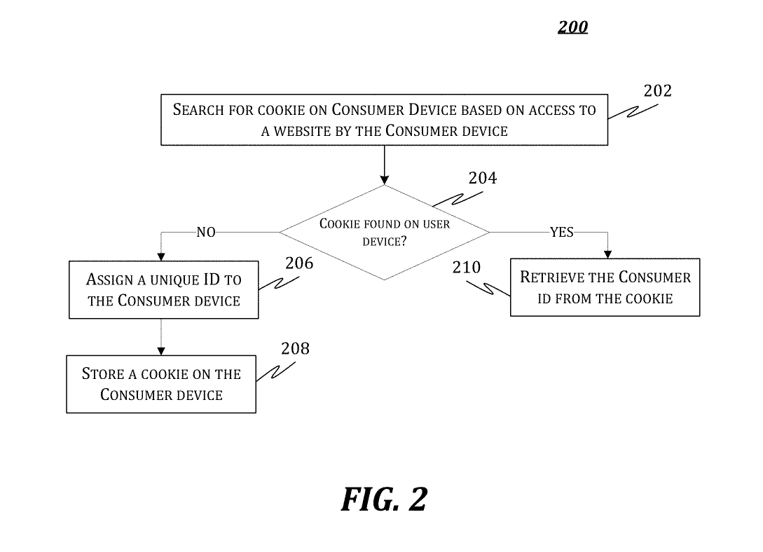

When a potential in-market prospect (hereinafter referred to as a “consumer”) visits a webpage, a code, such as Javascript code, embedded in the webpage may execute a method 200 as illustrated in FIG. 2. Accordingly, at stage 202, the code may search for a cookie on the consumer device associated with the consumer. Subsequently, at stage 204, a check is performed to determine whether the cookie was found on the consumer device. If no cookie is found, at stage 206, the code may assign a unique identifier (ID) to the consumer if no unique ID has been previously assigned. Subsequently, at stage 208, the code may store a cookie on the consumer device with the ID, among other information. On the other hand, if the code searches and finds a cookie on the consumer device, at stage 210, the unique ID stored in the cookie is retrieved. In this case, the cookie may have been previously stored when the consumer device accessed the webpage and/or any other webpage in the network of webpages in the past.

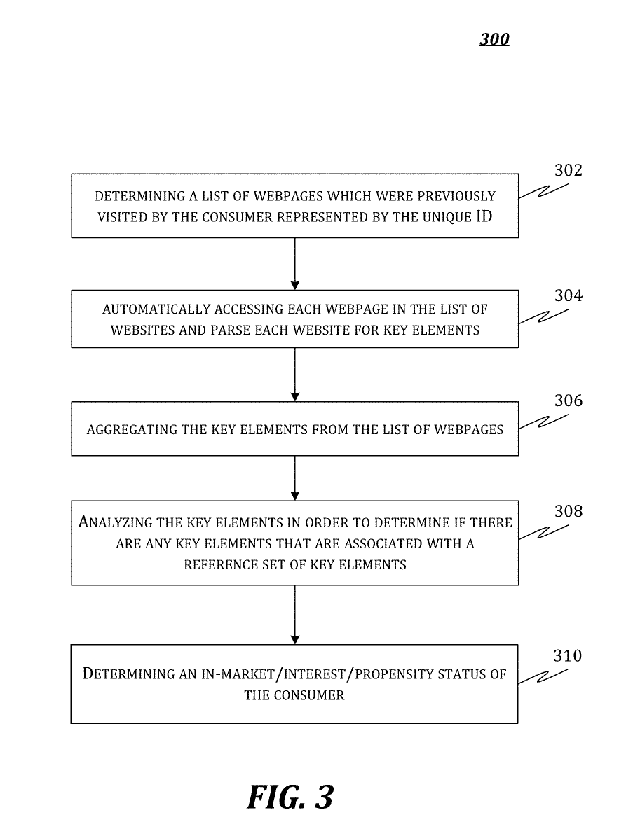

According to some embodiments, when the consumer visits a webpage using the consumer device, the webpage may be able to identify the unique ID associated with the consumer based on information associated with the consumer device and subsequently execute a method 300 as illustrated in FIG. 3.

In various other anticipated embodiments, method 300 would not require the execution of method 200 as a triggering event. For example, in some embodiments, the unique IDs may be determined based on, for example, cross-referencing at least one dataset belonging to a platform user to at least one dataset available to the platform (e.g., using email-hash cross-referencing techniques). As such, during an on-boarding or setup phase, a platform user may provide at least one of the following: 1) a list of targeted lead data (which may include, but not be limited to, at least one non-personally indefinable data point for the leads); and 2) areas of targeted lead interest (which may include, but not be limited to, for example keywords). In other embodiments, lead data may not be provided. Instead, as another example, a platform user may provide a desired threshold ‘confidence level’ associated with the areas of targeted lead interest. In turn, the platform may be enabled to assess the universe of unique IDs to determine which of those unique IDs may be associated with a threshold confidence level for key elements corresponding to the area of targeted lead interest.

Consistent with embodiments, method 300 may begin at stage 302, which may include identifying and logging a list of webpages which were previously visited by the consumer represented by a unique ID of interest. Moreover, the platform may be enabled to maintain or access an up-to-date list all webpages visit by the identified consumer after a triggering event.

Determining the unique ID of interest may be established by, for example, but not limited to, method 200. In some embodiments, a platform user may upload a list of unique IDs for tracking purposes. In other embodiments, the unique IDs may be determined based on, for example, cross-referencing at least one dataset belonging to a platform user to at least one dataset available to the platform (e.g., using email-hash, social handle, address, phone number, and other non-PII and/or PII cross-referencing techniques).

The method 300 may include a stage 304 of automatically accessing each webpage in the list of webpages and parse each webpage for key elements. Key elements, as used herein, may include, but not be limited to, webpage structure, text, images, video, audio, and combinations thereof. In some embodiments, the webpage may have been previously processed in accordance to this stage.

Additionally, the method 300 may include a stage 306 of aggregating the key elements from the list of webpages. In some embodiments, the webpage may have been previously processed in accordance to this stage.

Further, the method 300 may include a stage 308 of analyzing the key elements. As one example of an analysis stage, the platform may be configured to assign scores to key elements in order to determine if there are any key elements that are associated with a set of reference key elements (e.g., established during a setup or onboarding phase). As such, the scores may be assigned based on a comparison between the key elements and the reference key elements obtained during the setup phase. Furthermore, the method may include identifying one or more patterns in the key elements. The one or more patterns may be identified based on the raw data comprising the key elements, machine learning, AI processing of the key elements and so on. It should be understood that the method of ‘scoring’ is only one of many possible techniques to perform an analysis consistent with the present disclosure.

Additionally, in some instances, the method 300 may further include a stage of adding a weight to more recent key elements. In other words, the method may incorporate a time factor. Accordingly, for instance, if more than 3 webpages with recent key elements are identified, such key elements are identified as ‘younger key elements’ and accordingly given a higher weight in determining whether the consumer is in-market. It should be understood that the method of ‘weighting’ is only one of many possible techniques to perform an analysis consistent with the present disclosure.

For example, if the consumer visited three webpages containing content on Nike running shoes within a predetermined period of time (e.g, may be established during a setup or onboarding phase), then they are determined to be in-market for Nike running shoes.

Upon analysis, the method 300 may further include a stage 310 determining the in-market (e.g., interest/propensity) status of the consumer in one or more of the consumer device. For example, a data field associated with the Unique ID may be set to ‘true,’ ‘in-market,’ or ‘interested’.

Further, according to some embodiments, the method may include cross referencing the consumer with a Customer Relationship Management (CRM) database associated with a platform user. For example, data associated with the consumer, such as, but not limited to, the in-market status of the consumer in relation to one or more products and/or services along with respective confidence values, key elements, the list of webpages visited etc. may be stored in a record associated with the consumer in the CRM database. The data may further include propensity and interest-level data for each cross referenced consumer in the CRM database. (See the '178 disclosure.) This may be done based on, for example, a common reference point. For example, the login provided by the consumer may be associated with an email address of the consumer as stored in the CRM database through a network cookie. Other common reference points may be used, such as, for example, but not limited to email-hash, social handle, address, phone number, and other non-PII and/or PII cross-reference elements.

Additionally, in some embodiments, the method may include triggering a marketing campaign based on the in-market status of the consumer. For example, the marketing campaign may include be carried out on one or more channels such as, email, SMS, social media messaging, telephonic calls, video calls, in-person meetings etc.

The aforementioned stages may be repeated for dynamically updated lists of webpages the consumer has been determined to have visited. In such update, the data field may be modified based on the new data. Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of methods 200 and 300 will be described in greater detail below.

IV. Platform Architecture

The online platform 100 may be embodied as, for example, but not be limited to, a webpage, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although methods 200 and 300 have been described to be performed by a computing device 400, it should be understood that, in some embodiments, different operations may be performed by different networked elements in operative communication with computing device 400.

Embodiments of the present disclosure may comprise a system having a memory storage and a processing unit. The processing unit coupled to the memory storage, wherein the processing unit is configured to perform the stages of methods 200 and 300.

FIG. 4 is a block diagram of a system including computing device 400. Consistent with an embodiment of the disclosure, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the disclosure.

With reference to FIG. 4, a system consistent with an embodiment of the disclosure may include a computing device or cloud service, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., application 420) may perform processes including, for example, stages of one or more of methods 200 and 300 as described above. The aforementioned process is an example, and processing unit 402 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

The following is claimed:

1. A computer implemented method for predicting an interest level of a consumer, the computer implemented method comprising:
monitoring online behavior of a consumer device operated by the consumer across a plurality of webpages;
analyzing the online behavior; and
determining an in-market status of the consumer corresponding to at least one of product and a service based on the analyzing.

2. The computer implemented method of claim 1, further comprising determining a confidence value associated with the in-market status, wherein the confidence value represents a degree of certainty of the consumer's intention to purchase at least one of the product and the service.

3. The computer implemented method of claim 2, wherein the in-market status corresponds to at least one of a plurality of products and a plurality of services, wherein the confident value comprises a plurality of confidence values associated with at least one of the plurality of products and the plurality of services.

4. The computer implemented method of claim 1, wherein the monitoring comprises extracting at least one key element from a webpage visited by the consumer.

5. The computer implemented method of claim 1, wherein the monitoring comprises extracting content from the plurality of webpages, wherein the analyzing comprises performing machine learning over content.

6. The computer implemented method of claim 5, wherein the machine learning is at least one of a supervised machine learning and an unsupervised machine learning.

7. The computer implemented method of claim 1, wherein the online behavior comprises at least one of visiting the plurality of webpages, interacting with the plurality of webpages, downloading the plurality of webpages, purchasing at least one of a product and a service associated with the plurality of webpages.

8. The computer implemented method of claim 1, wherein the online behavior comprises performing a payment at a Point of Sale (POS) terminal, wherein the payment is towards at least one of a product and a service associated with the plurality of webpages.

9. The computer implemented method of claim 1 further comprising storing a tracking cookie on a consumer device operated by the consumer, wherein the monitoring is performed by the tracking cookie.

10. The computer implemented method of claim 1, wherein each of the plurality of webpages comprises a tracking cookie configured to perform the monitoring.

11. The computer implemented method of claim 1, wherein the plurality of webpages corresponds to a plurality of servers, wherein a first server of the plurality of servers is configured to communicate with a second server of the plurality of servers, wherein the communication comprises online behavior of the consumer captured by the first server.

12. The computer implemented method of claim 1 further comprising receiving indication of at least one of the product and the service from a publisher of at least one webpage of the plurality of webpages.

13. The computer implemented method of claim 1 further comprising:
parsing content of at least one webpage of the plurality of webpages; and
identifying at least one of the product and the service based on the parsing.

14. The computer implemented method of claim 13 further comprising extracting a reference set of key elements associated with at least one of the product and the service based on the parsing.

15. The computer implemented method of claim 14, wherein monitoring of at least one other webpage of the plurality of webpage is based on the set of key elements.

16. The computer implemented method of claim 1 further comprising:
receiving a request to access a webpage of the plurality of webpages by a consumer device operated by the consumer;
identifying the consumer based on at least one unique identifier associated with the request;
identifying at least one other webpage of the plurality of webpages visited by the consumer based on the at least one unique identifier; and
extracting a set of key elements from the at least one other webpage, wherein the analyzing comprises analyzing the set of key elements, wherein determining the in-market status of the consumer for at least one of the product and the service offered by the webpage is based on analyzing of the set of key elements.

17. The computer implemented method of claim 16, wherein analyzing the set of key elements comprises comparing the set of key elements with a reference set of key elements associated with the webpage, wherein the reference set of key elements represents at least one of the product and the service offered by the webpage.

18. The computer implemented method of claim 1, further comprising storing an in-market indicator on at least one of the consumer device and a server provisioning at least one webpage of the plurality of webpages.

19. The computer implemented method of claim 1, further comprising:
receiving a request to access a webpage by a consumer device operated by the consumer;
identifying the consumer based on at least one unique identifier associated with the request;
retrieving the in-market status associated with the consumer; and
transmitting at least one advertisement to the consumer device based on the in-market status.

20. The computer implemented method of claim 1, further comprising updating a CRM database associated with at least one of the plurality of webpages with the in-market status of the consumer.
